(19) United States
(12) Patent Application Publication
(10) Pub. No.: US 2004/0252749 A1
(43) Pub. Date: Dec. 16, 2004

(54) Apparatus for performing a temperature measurement function and devices based thereon

(76) Inventor: Christoph Stefan Randazzo, Baden (CH)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(21) Appl. No.: 10/631,049

(22) Filed: Jul. 28, 2003

(30) Foreign Application Priority Data
Jun. 13, 2003 (EP) 03101736.1

(51) Int. Cl. G01J 5/00

(52) U.S. Cl. 374/178

(57) ABSTRACT

An apparatus (20) for performing a temperature measurement function is proposed. It comprises a first circuit (11) and a second circuit (12). The first circuit (11) has a transistor (M1), a resistor (Rₜₑₘₚ), and a parallel arrangement of n diodes (B1-Bn). The second circuit (12) comprises a transistor (M2) and a parallel arrangement of m diodes (C2). An operational amplifier (13) is on the input side being connected to the first circuit (11) and the second circuit (12). This operational amplifier (13) provides a gate voltage for the transistors (M1, M2). There is an output stage with p output transistors (N1-Np), and an output resistor (r*Rₜₑₘₚ). The output stage performs a current to output voltage conversion in order to provide an output voltage (Vₜₑₘₚₒᵤₜ) that depends on the actual temperature (T).

The present invention concerns apparatus for performing a temperature measurement function and integrated circuits based thereon.

There are many integrated circuit applications requiring a temperature measurement function. The temperature measurement may be necessary to compensate for temperature dependent changes in the frequency of a modulated signal or to compensate for temperature dependent changes in the gain of an amplifier, just to mention two examples.

Conventional solutions normally use an integrated, switchable current source, an analog-to-digital converter (ADC) and an external diode.

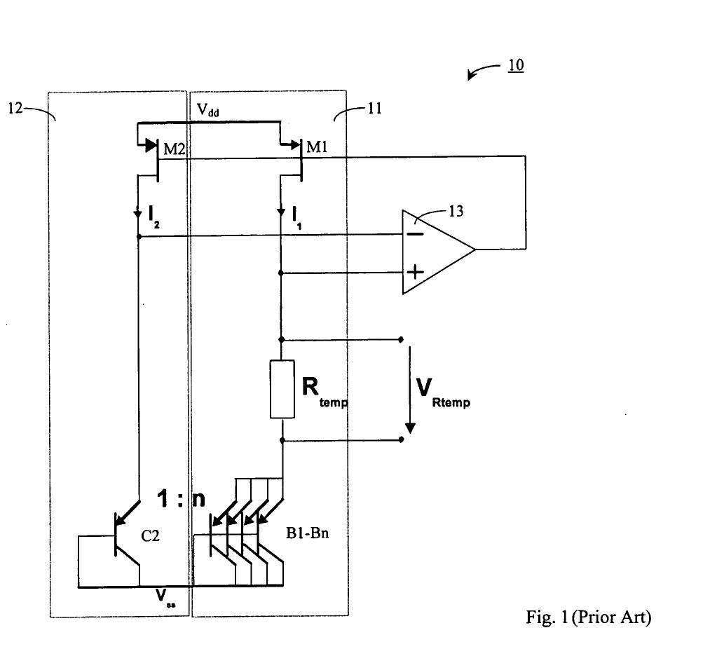

A proportional-to-absolute-temperature (PTAT) structure has been proposed which performs a temperature measurement function without requiring any external diodes or the like. A PTAT structure 10 is illustrated in FIG. 1. The PTAT structure 10 employs CMOS transistors M1, M2 and bipolar transistors B1 through Bn and C2. There is a first circuit 11 and a second circuit 12 being arranged in parallel. The first circuit 11 comprises a transistor M1, a resistor Rₜₑₘₚ, and a parallel arrangement of n bipolar transistors B1 through Bn (n is an integer number). These transistors B1 through Bn are diode-connected PNP bipolar transistors serving as diodes. The second circuit 12 comprises a transistor M2 and one bipolar transistor C2. An operational amplifier 13 is on its input side connected to the first circuit 11 and the second circuit 12. The transistors M1 and M2 serve as voltage dependent current sources. The operational amplifier 13 provides for a biasing of the transistor M1 and the transistor M2 by applying a gate voltage to these transistors M1, M2. The gate voltage is supplied by the output of the operational amplifier 13. A voltage V_{Rtemp} is provided across the resistor Rₜₑₘₚ. It can be proven, that the voltage V_{Rtemp} is linearly proportional to the absolute temperature T. The following equation is valid:

VRₜₑₘₚ=(kT)/q·ln(n)

Whereby the following constants are used:

Bolzmann constant: k=1.381·10⁻²³ J/° K

Electron charge: q=1.6·10⁻¹⁹ C

$$and \frac{kT}{q} [ T = 300 ° K . ] = 25.86 mV$$

This voltage V_{Rtemp} can be used for temperature detection. But actually it is not wise to do so, because the PTAT structure 10 is very sensitive on any loading of the internal nodes. Any such loading of the output will lead to inaccurate measurements. That is the main reason, why the basic PTAT structure 10 is not suitable for direct temperature measurements. It is a disadvantage of the known PTAT structures, that—if subjected to a load—they are not suitable for a accurate measurements. It is another disadvantage of the conventional PTAT structure 10, that the output voltage V_{Rtemp} is rather small.

It is thus an objective of the present invention to provide a scheme for performing a temperature measurement function being more accurate.

Accordingly, an extended PTAT structure is proposed and claimed.

An apparatus in accordance with the present invention is claimed in claim 1. Various advantageous embodiments are claimed in claims 2 through 15.

A device comprising such an apparatus is claimed in independent claim 16.

Various advantageous embodiments are claimed in claims 17 through 18.

Immediate benefits of this invention are improved quality and competitiveness. The proposed apparatus and the devices based thereon are simple and cheap. The apparatus and devices according to the present invention are less sensitive to any disturbance.

It is another advantage of the solution presented herein that it is completely integrated and thus does not need external components.

The present invention can be used to make a stable digital temperature-monitoring device, for example.

Other advantages of the present invention are addressed in connection with the detailed embodiments.

For a more complete description of the present invention and for further objects and advantages thereof, reference is made to the following description, taken in conjunction with the accompanying drawings, in which:

FIG. 1 shows a schematic block diagram of a conventional PTAT structure;

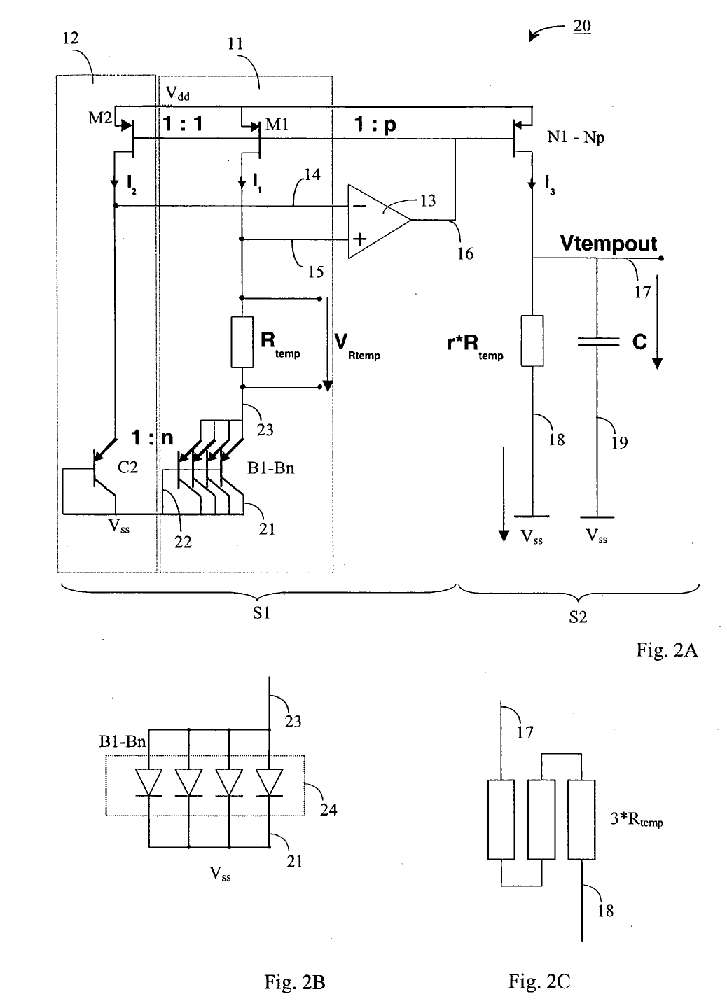

FIG. 2A shows a schematic block diagram of a first apparatus in accordance with the present invention;

FIG. 2B shows the diodes of the transistors B1-Bn of the first apparatus;

FIG. 2C shows the resistor r*Rₜₑₘₚ of the first apparatus;

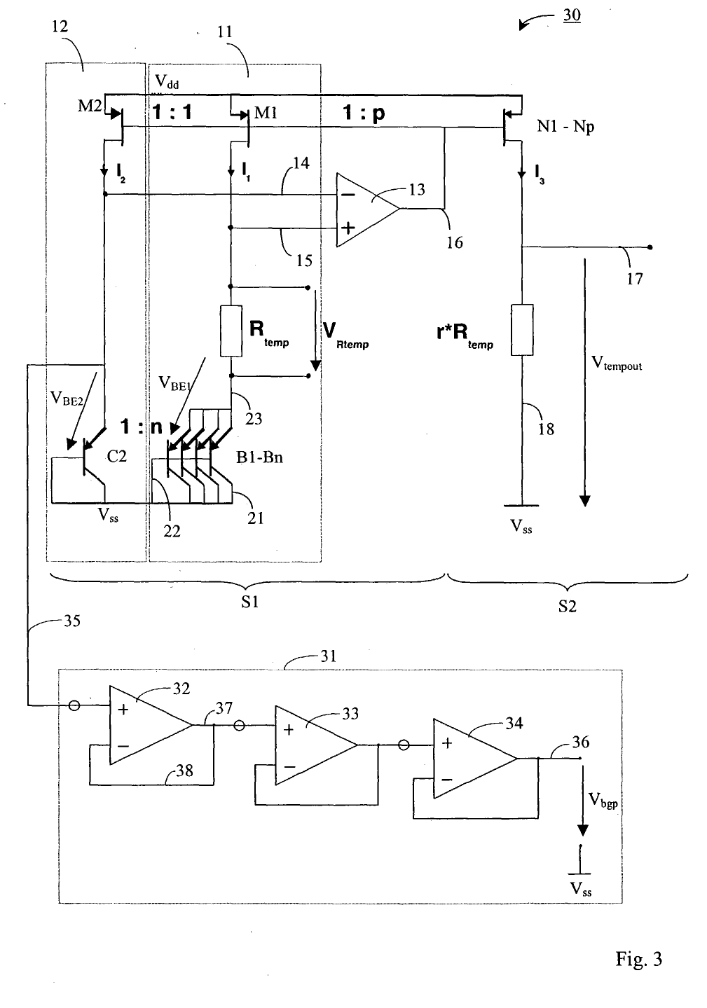

FIG. 3 shows a schematic block diagram of a second apparatus in accordance with the present invention;

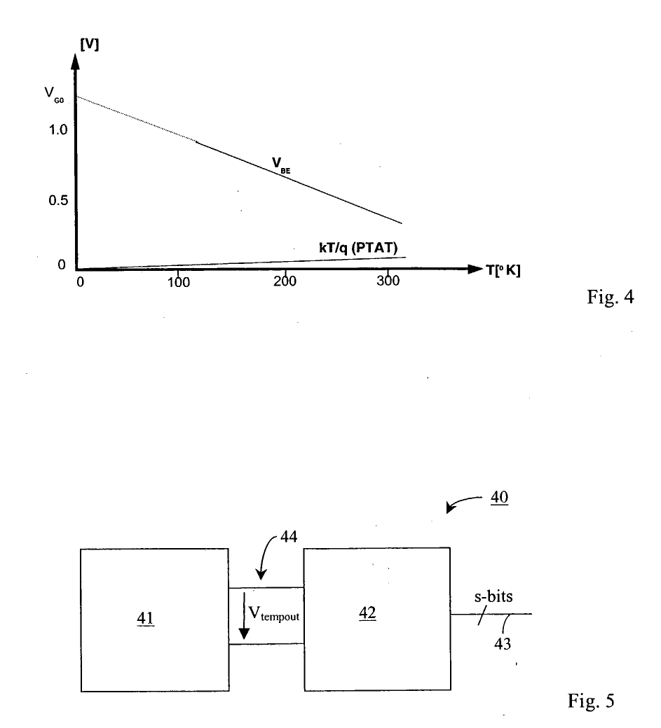

FIG. 4 shows the V_{BE} and the kT/q curves in dependence of the temperature T;

FIG. 5 shows a schematic block diagram of a third apparatus in accordance with the present invention;

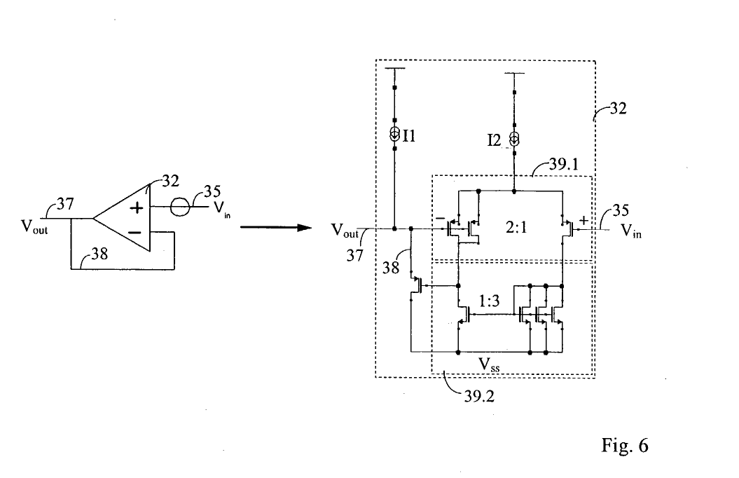

FIG. 6 shows on the left side the schematic block diagram of a voltage follower and on the right side details of one possible implementation of such a voltage follower.

The present invention is based on the PTAT structure illustrated in FIG. 1. A first apparatus 20, in accordance with the present invention, is illustrated in FIGS. 2A through 2C. The apparatus 20 comprises a first stage S1 that is similar to or identical with the PTAT structure of FIG. 1. The first stage S1 employs CMOS transistors M1, M2 and bipolar transistors B1 through Bn and C2. There is a first circuit 11 and a second circuit 12 being arranged in parallel. The first circuit 11 comprises a transistor M1, a resistor Rₜₑₘₚ, and a parallel arrangement of n bipolar transistors B1 through Bn. These transistors B1 through Bn are diode-connected PNP bipolar transistors serving as diodes, as illustrated in FIG. 2B with n=4. The bases 22 and the collectors 21 of the transistors B1 through Bn are short-circuited. The bipolar transistors are connected as forward-feeding diodes (cf. FIG. 2B). The second circuit 12 comprises one transistor M2 and one bipolar transistor C2. This embodiment can be generalized by providing m bipolar transistors with m<n (m and n are integers). The transistor C2 is also a diode-connected PNP bipolar transistor serving as diode. The input 14 of the operational amplifier 13 is connected to the drain of the transistor M2 and the input 15 is connected to the drain of the transistor M1. The input of the operational amplifier 13 has a very high impedance and almost no current flows into the inputs 14, 15 (note that this is valid for an ideal operational amplifier only). The transistors M1 and M2 serve as voltage dependent current sources. The operational amplifier 13 provides for a biasing of the transistor M1 and the transistor M2 by applying a gate voltage to these transistors M1, M2. The gate voltage is supplied by the output 16 of the operational amplifier 13. The same gate voltage is also applied to the gate of the transistors N1 through Np. The first transistor M1 provides a first current I1 flowing through the parallel arrangement of n transistors B1-Bn and the second transistor M2 provides a second current I2 flowing through the transistor C2, as depicted in FIG. 2. A voltage VRₜₑₘₚ is provided across the resistor Rₜₑₘₚ.

The base-emitter voltage V_{BE} of a bipolar transistor decreases almost linearly with temperature T. The temperature coefficient is dependent on the emitter current density.

The difference ΔV_{BE}=V_{BE1}−V_{BE2} between the two base-emitter voltages is a first-order approximation that is linearly proportional to the absolute temperature T. Therefore, the output voltage Vₜₑₘₚₒᵤₜ is temperature dependent, too.

According to the present invention, a second stage S2 with p additional CMOS transistors N1 through Np and a resistor r*Rₜₑₘₚ was introduced (p and r are integers). The ratios 1:p and 1:r can be chosen independently from each other. Depending on these ratios, the output voltage level Vₜₑₘₚₒᵤₜ at the output 17 can be adjusted. The voltage V_{Rtemp} of the first stage S1 is not used, since any load applied to the resistor Rₜₑₘₚ would have a negative influence on the first stage's performance and accuracy.

By the second stage S2, the current I1 is mirrored and multiplied by a factor of p and then transformed to the output voltage Vₜₑₘₚₒᵤₜ by the resistor r*Rₜₑₘₚ. In this way a current amplification and a current to voltage conversion is carried out. Please note that the current amplification is optional.

The output voltage Vₜₑₘₚₒᵤₜ is again a linear and proportional function of the absolute temperature T, and the following equations are valid:

I₃=p·I₁

Vₜₑₘₚₒᵤₜ=p·r·kT/q·ln(n)

These equations indicate that the output voltage Vₜₑₘₚₒᵤₜ depends only on the ratios p, r, n and the absolute temperature T, but not on any other absolute values. The nodes 18, 19 can be connected to ground, or these nodes 18, 19 can be connected to any desired reference voltage. In the embodiment of FIG. 2, the nodes 18, 19 are connected to Vss.

Preferably, the transistors M3 and the output resistors r*Rₜₑₘₚ comprise identical devices like M1 and Rₜₑₘₚ. In order to achieve this, it is recommended to use multiple identical elements. An example is illustrated in FIG. 2C. In order to obtain a total resistance R=r*Rₜₑₘₚ, r resistors each having a resistance of Rₜₑₘₚ are arranged in series.

Using identical devices is advisable, because in this way mismatch effects can be reduced to a minimum. Non-ideal effects of the elements will be cancelled by each other. At the output 17 a small optional hold-capacitor C may be connected. This is done to stabilize the voltage Vₜₑₘₚₒᵤₜ for the duration of an additional internal analog-to-digital conversion (cf. FIG. 5, for example). This capacitor C is optional.

The output 17 should not be connected directly to a low-ohmic load since as a consequence the temperature measurement may be inaccurate. In this case, again a hold-capacitor C would be appropriate. The total error of the output voltage Vₜₑₘₚₒᵤₜ depends mainly on the accuracy of the basic PTAT block (first stage S1).

Special care should be taken in the design of the internal operational amplifier 13. The offset of this operational amplifier 13 will reduce the performance of the whole system 20. Well suited is a low-offset operational amplifier.

Under ideal conditions (regarding design rules to minimize mismatch effects) the additional stage S2 will not affect the performance of the temperature measurement.

A second apparatus 30 is now described in connection with FIG. 3. This second apparatus 30 combines both bandgap reference voltage and the temperature measurement function in one circuit, reusing the basic structure.

On the right side of the operational amplifier 13, the temperature sensing part is drawn (second stage S2). The second stage S2 may be similar to or identical with the second stage S2 of FIG. 2. It may comprise mainly a resistor r*Rₜₑₘₚ and p transistors N1-Np. In the present embodiment, the hold-capacitor C is omitted. Together with the common basic structure (first stage S1), the second stage S2 provides a temperature dependent output voltage Vₜₑₘₚₒᵤₜ. The first stage S1 may be similar to or identical with the PTAT structure of FIG. 1 or FIG. 2.

Below the stages S1 and S2, a temperature compensation network 31 is drawn. The input 35 of this network 31 is connected to the drain of the transistor M2. The temperature compensation network 31 comprises a plurality of operational amplifiers 32, 33, 34 arranged as offset compensation voltage followers. The internal voltage V_{BE2} at the input 35 consists of a fix voltage V_{G0} and a temperature dependent part. In a first order approximation, the following equation is valid:

$${V}_{BE} = {V}_{G0} - \frac{kT}{q} \cdot ln \frac{c}{{I}_{C}}$$

Whereas:

V_{G0}: bandgap voltage extrapolated to T=0° K; V_{G0}˜1.21V for a CMOS process

c: technology dependent constant

I_{C}: collector current density of I2

k: Bolzmann constant k=1.381 10⁻²³ J/° K

q: Electron charge: q=1.6·10⁻¹⁹ C

$$and \frac{kT}{q} [ T = 300 ° K . ] = 25.86 mV ;$$

this term is proportional to the absolute temperature T.

In FIG. 4, the curves for V_{BE} and the term kT/q in dependence of the temperature T are shown. In this Figure it is depicted that the two curves have slopes of different sign.

The temperature dependent part has to be compensated in order to provide a stable reference voltage. There are several possibilities to do this. In the present context, an embodiment is proposed, that provides an accurate, stable reference voltage V_{bgp} at a low power supply level. Normally, bandgap reference voltages are around 1.25V. For newer processes this is too high. According to the present invention, the negative temperature gradient of the voltage V_{BE} across the PNP transistor C2 is compensated by cascaded voltage followers 32, 33, and 34. These voltage followers 32, 33, and 34 have a built-in kT/q offset. This offset is obtained by introducing an intentional size mismatch between the transistors of an input stage of the voltage followers or/and a non-unity mirror gain. Several voltage followers (e.g., 3 voltage followers 32, 33, and 34), with an implemented offset, are connected in series, until the complete negative temperature gradient of kT/q is compensated. As a result, the final reference voltage V_{bgp} voltage is stable and flat over the total temperature range.

It is an advantage of the apparatus 30, that together with the stages S1 and S2, the temperature compensation network 31 provides a stable, temperature independent reference voltage V_{bgp} at the output 36.

It is an advantage of the embodiment presented and described in connection with FIG. 3, that the mismatch effects of the supplying reference operational amplifiers is negligible. Normally this is the limiting factor in common bandgap reference voltage designs.

FIG. 6 shows on the left side the schematic block diagram of one of the voltage followers of

FIG. 3, namely voltage follower 32. On the right, details of one possible implementation of

such a voltage follower 32 are illustrated. The voltage follower 32 comprises two current

sources designated with I1 and I2. The voltage follower 32 further comprises an asymmetric input stage 39.1 and an asymmetric active load 39.2 (intentional size mismatch). The asymmetric input stage 39.1 has two transistors in a left branch and one transistor in a right branch. These transistors are identical and the ratio is thus 2:1. The asymmetric active load 39.2 comprises one transistor in the left branch and three transistor in a right branch. These transistors are identical and the ratio is thus 1:3. The voltage follower 32 has an implemented offset due to the asymmetric set-up.

According to the present invention, the stages S1 and S2 can be set up in a way, that the requirements for both functions (bandgap reference and temperature measurement) are fulfilled in a satisfying manner. It can be shown, that the effort to implement both functions at the same time can be reduced to a minimum. With very few extra element, an additional, powerful feature can be easily implemented.

According to a preferred embodiment, the elements of the temperature compensation network 31 are designed in a common CMOS process. The diodes of the first circuit 11 and the second circuit 11 are realized as vertical PNP bipolar transistors, for example. The PNP bipolar transistors can be realized in a CMOS process or in a Bi-CMOS process, for example.

A device 40, according to the present invention, is illustrated in FIG. 5. This device 40 comprises an apparatus 41 implementing the invention described in connection with FIGS. 2A through 3. This apparatus 41 provides a stable and reliable, analog output voltage Vₜₑₘₚₒᵤₜ at an output 44. The device 40 further comprises an analog-to-digital converter 42. This analog-to-digital converter 42 converts the analog signal Vₜₑₘₚₒᵤₜ into a digital output signal. This digital output signal is made available at an output bus 43. In the present embodiment the output bus a s-bits wide and the analog-to-digital converter 42 is an s-bit converter. A capacitor may be provided at the output 44 of the apparatus 41 in to stabilize the voltage Vₜₑₘₚₒᵤₜ for the duration of the analog-to-digital conversion.

According to a preferred embodiment, the resistor Rₜₑₘₚ and the output resistor r*Rₜₑₘₚ may be both either integrated Npoly resistors or integrated Ppoly resistors.

The apparatus according to the present invention can be implemented in every device, which needs to measure the temperature. Also a stand-alone solution for temperature measurement only is possible. Designs, which have already a bandgap reference voltage block and an internal analog-to-digital converter integrated, have the advantage, that the main infrastructure is already available and these blocks can be reused. In this case the temperature measurement function is more or less for free since only some small modifications are required.

The apparatus according to the present invention can be employed in many applications ranging from purely analog, mixed-mode, to purely digital devices.

The demand for low voltage references is especially apparent in mobile battery operated devices, such as cellular phones, pagers, camera recorders, and laptops. Consequently, low voltage and low quiescent current flow are intrinsic and required characteristics conducive toward increased battery efficiency and longevity. In such devices, an apparatus in accordance with FIG. 3 can be used.

This patent proposal describes an easy and accurate method for a better temperature measurement. The basic PTAT is extended by additional output stage (second stage S2) and an optional temperature compensation network 31.

The invention even allows a scaling of the output voltage Vₜₑₘₚₒᵤₜ and a shifting of the reference level, without introducing an additional error.

It is an advantage of the apparatus presented herein that under every condition the apparatus is stable. The temperature could clearly be detected.

The invention is well suited for compensating temperature variations in high precision circuits.

It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable sub combination.

In the drawings and specification there has been set forth preferred embodiments of the invention and, although specific terms are used, the description thus given uses terminology in a generic and descriptive sense only and not for purposes of limitation.

1. Apparatus (20; 30; 41) for performing a temperature measurement function, comprising a first stage with
a first circuit (11) and a second circuit (12) being arranged in parallel, said first circuit (11) comprising a first transistor (M1), a first resistor (Rₜₑₘₚ), and a parallel arrangement of n diodes (B1-Bn),
said second circuit (12) comprising a second transistor (M2) and a parallel arrangement of m diodes (C2),
an operational amplifier (13) on the input side being connected to the first circuit (11) and the second circuit (12), said operational amplifier (13) applying a gate voltage to said first transistor (M1) and said second transistor (M2),
said apparatus (20; 30; 41) further comprising an output stage with p output transistors (N1-Np), and an output resistor (r*Rₜₑₘₚ) performing a current to output voltage conversion in order to provide an output voltage (Vₜₑₘₚₒᵤₜ) that depends on the actual temperature (T).

2. The Apparatus (20; 30; 41) of claim 1, wherein said first transistor (M1) provides a first current (I1) flowing through the parallel arrangement of n diodes (Bi-Bn) and said second transistor (M2) provides a second current (12) flowing through the parallel arrangement of m diodes (C2).

3. The Apparatus (20; 30; 41) of claim 1, wherein said operational amplifier (13) has a first input (15), a second input (14), and an output (16), the first input (15) being connected to a drain of the first transistor (M1) and the second input (14) being connected to a drain of the second transistor (M2), said output (16) being connected to a gate of said first transistor (M1) and a gate of said second transistor (M2) for biasing these transistors (M1, M2).

4. The Apparatus (20; 30; 41) of claim 1, wherein said output stage amplifies a first current (I1) to obtain a third current (13) before performing said current to output voltage conversion by converting said third current (13) into said output voltage (Vₜₑₘₚₒᵤₜ)

5. The Apparatus (20; 30; 41) of claim 1 wherein said first resistor (Rₜₑₘₚ) and said output resistor (r*Rₜₑₘₚ) are both either integrated Npoly resistors or integrated Ppoly resistors.

6. The Apparatus (20; 30; 41) of claim 1, wherein said output resistor (Rₜₑₘₚ) is realized by a plurality of r resistors, the resistance of the output resistor (r*Rₜₑₘₚ) being r times the resistance of said first resistor (Rₜₑₘₚ), r being an integer number.

7. The Apparatus (20; 30; 41) of claim 1, comprising a hold-capacitor (C) being arranged in parallel to the output resistor (r*Rₜₑₘₚ) in order to filter out noise and/or to stabilize said output voltage (Vₜₑₘₚₒᵤₜ).

8. The Apparatus (20; 30; 41) of claim 1, wherein said first transistor (M1) and said output transistors (N1-Np), as well as said first resistor (Rₜₑₘₚ) and output resistor (r*Rₜₑₘₚ) are designed to minimize mismatch effects.

9. The Apparatus (20; 30; 41) of claim 1, wherein said number n, m and p are integer numbers.

10. The Apparatus (20; 30; 41) of claim 1, wherein diode-connected PNP bipolar transistors (B1-Bn, C2) serve as diodes.

11. The Apparatus (20; 30; 41) of claim 1, wherein said operational amplifier (13) is a low-offset operational amplifier.

12. The Apparatus (20; 30; 41) of claim 1, wherein the output voltage Vₜₑₘₚₒᵤₜ) and the actual temperature (T) have a linear dependency.

13. The Apparatus (20; 30; 41) of claim 1, wherein the gate voltage is applied to gates of the p output transistors (Ni-Np).

14. The Apparatus (30) of claim 1 further comprising a temperature compensation network (31) providing a bandgap reference voltage (V_{bgp}) at another output (36).

15. The Apparatus (30) of claim 14, wherein the temperature compensation network (31) comprises a plurality of voltage followers (32, 33, 34) with an implemented offset, the voltage followers (32, 33, 34) being connected in series.

16. Device (40) including an apparatus (41) according to claim 1.

17. The device (40) of claim 16, further comprising an analog-to-digital converter (42).

18. The device (40) of claim 16 being part of a circuit, the circuit including at least one of the following: an analog device, a mixed-mode device, or a digital device.
